(19) United States
(12) Patent Application Publication
(10) Pub. No.: US 2015/0354501 A1
(43) Pub. Date: Dec. 10, 2015

(54) Non-Axisymmetric Exit Guide Vane Design

(71) Applicant: UNITED TECHNOLOGIES CORPORATION, Hartford, CT (US)

(72) Inventors: Razvan Virgil Florea, Manchester, CT (US); Mark B. Stucky, Glastonbury, CT (US); Dmytro Mykolayovych Voytovych, Rocky Hill, CT (US); Aamir Shabbir, Westlake, OH (US)

(21) Appl. No.: 14/296,769

(22) Filed: Jun. 5, 2014

(51) Int. Cl. F02K 1/82

(52) U.S. Cl. CPC F02K 1/82

(57) ABSTRACT

An exit nozzle section for an engine has an outer wall and an inner wall, and a plurality of exit guide vanes extending between the outer wall and the inner wall. Different ones of the exit guide vanes having different cambers in different regions of the exit nozzle section.

### CROSS REFERENCE TO RELATED APPLICATION

This application claims the benefit of provisional application Ser. No 61/720,517, filed Oct. 31, 2012.

### STATEMENT OF GOVERNMENT INTEREST

The subject matter described herein was made with government support under Contract No. NNC07CB59C awarded by NASA. The government of the United States of America may have rights to the subject matter described herein.

### BACKGROUND

The present disclosure is directed to a non-axisymmetric exit guide vane for use in a gas turbine engine.

A goal for designers of future air vehicles and propulsion systems is to provide reductions in noise, emissions, and fuel burn relative to conventional aircraft and today's gas turbine engines. One path to achieve this is to advance the design capabilities of embedded engines in blended wing body aircraft. The goal is to develop boundary layer ingesting propulsion systems, which can provide improvements in propulsive efficiency by producing thrust from the reduced velocity boundary layer air. The challenge is then shifted from the airframe to the propulsion system where high inlet flow distortion drives performance, aeromechanical, stability/operability and acoustic issues. The inlet duct and fan function as a system. The large flow distortions may lead to strong coupling between the fan and the upstream flow fields. The impact of the compromises in engine performance required to overcome these issues is a key question that must be addressed.

### SUMMARY

In accordance with the present disclosure, there is provided an exit nozzle section for an engine which broadly comprises an outer wall and an inner wall; a plurality of exit guide vanes extending between the outer wall and the inner wall; and different ones of the exit guide vanes having different cambers in different regions of the exit nozzle section.

In a further embodiment, the exit guide vanes may have different leading edge metal angles in the different regions of the exit nozzle section.

In a further embodiment of any of the foregoing embodiments, the different regions of the exit nozzle section may comprise a bottom region, a top region, and at least one transition region between the bottom region and the top region.

In a further embodiment of any of the foregoing embodiments, the outer wall and the inner wall may form a convergent flow passageway.

In a further embodiment of any of the foregoing embodiments, the outer wall may comprise a non-axisymmetric outer dimension.

In a further embodiment of any of the foregoing embodiments, the outer wall may have different configurations in the different regions of the exit nozzle section.

In a further embodiment of any of the foregoing embodiments, the outer wall may comprise a symmetric outer dimension.

In a further embodiment of any of the foregoing embodiments, the inner wall may be convergent with respect to the outer wall.

In a further embodiment of any of the foregoing embodiments the inner wall may comprise axisymmetric end-wall contouring.

In a further embodiment of any of the foregoing embodiments, the inner wall may have no end wall contouring.

In a further embodiment of any of the foregoing embodiments, each guide vane may have an inner dimension which corresponds to a configuration of the inner wall and an outer dimension which corresponds to a configuration of the outer wall.

In a further embodiment of any of the foregoing embodiments, the outer wall may be formed by a surface of a casing.

In a further embodiment of any of the foregoing embodiments, the exit nozzle section may further comprise a centerbody in the exit nozzle section and a surface of the centerbody forming the inner wall.

In a further embodiment of any of the foregoing embodiments, the inner wall may converge towards the outer wall to form a convergent flow path and the outer wall may have a non-axisymmetric configuration in the different regions of the exit nozzle section.

Other details of the non-axisymmetric exit guide vane design are set forth in the following detailed description and the accompanying drawings wherein like reference numerals depict like elements.

### BRIEF DESCRIPTION OF THE DRAWINGS

FIG. 1 illustrates a blended wing body aircraft;

FIG. 2 is a rear view of an exit nozzle section;

FIG. 3 is a cross section view of an exit nozzle section;

FIG. 4 is an enlarged view of the inner wall surface of the exit nozzle section of FIG. 3;

FIG. 5 illustrates the tailored cambers for the exit guide vanes; and

FIG. 6 illustrates the leading edge metal angles for the exit guide vanes.

### DETAILED DESCRIPTION

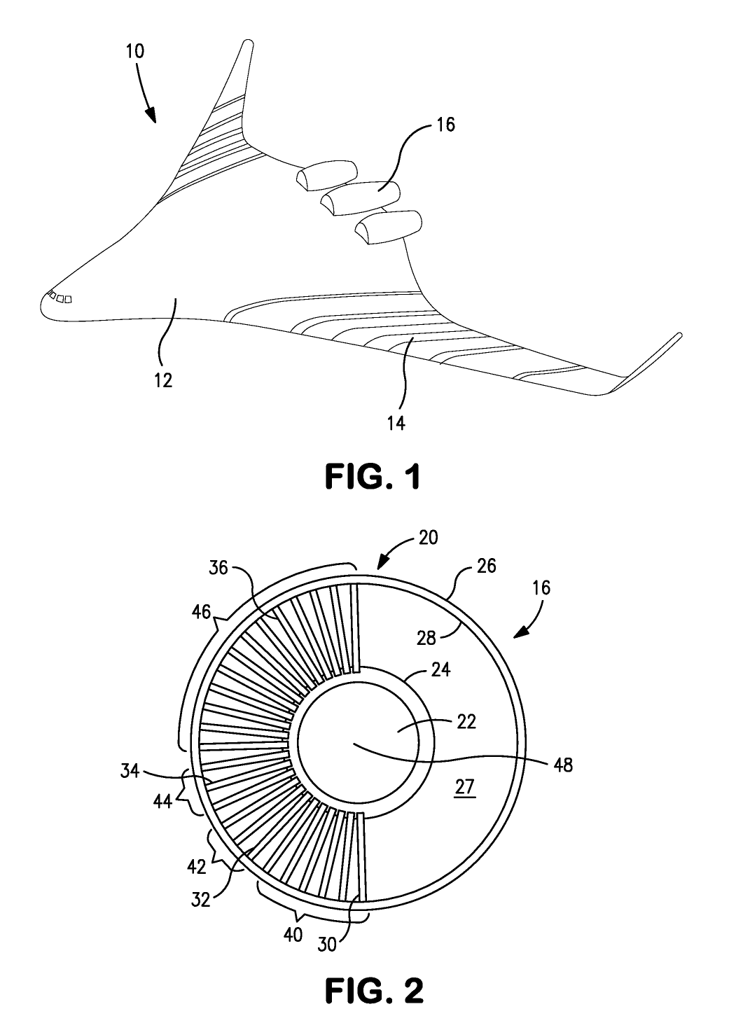

Referring now to FIG. 1, a blended wing body aircraft 10 is illustrated. The blended wing body aircraft 10 has a fuselage 12, wings 14, and a plurality of propulsion engines 16. The propulsion engines 16 may each be a gas turbine engine.

In an aircraft such as that shown in FIG. 1, a distortion-tolerant propulsion system that simultaneously minimizes reduction in fan efficiency and stall margin relative to a clean-inflow conventional baseline is desirable. The present disclosure addresses the exit guide vane design in the presence of upstream distortion, which is a significant component in a boundary layer ingestion distortion-tolerant propulsion system.

As will be discussed herein, axisymmetric and non-axisymmetric flow path convergence designs may be used as part of the exit portion in which the exit guide vane resides to reduce boundary layer growth and limit non-uniform flow distortion impact on exit guide vanes. Axisymmetric end-wall contouring design may be used to reduce losses and inner diameter separation associated with a thick or developed boundary layer. Still further, a tailored exit guide vane camber design may be used to account for flow distortion. Further, the leading edge metal angle for each individual guide vane or group of vanes may be repositioned to account for the local axial and radial flow angle.

The design of the present invention helps to avoid large wakes behind the exit guide vanes due to separation in the bottom inner diameter, over-speed (transonic flow) in the top exit guide vane flow passages. The exit guide vane design described herein reduces total pressure losses, eliminates vane and end-wall separation and increases mixing/reduce wake associated with incoming distortion from the inlet-fan system.

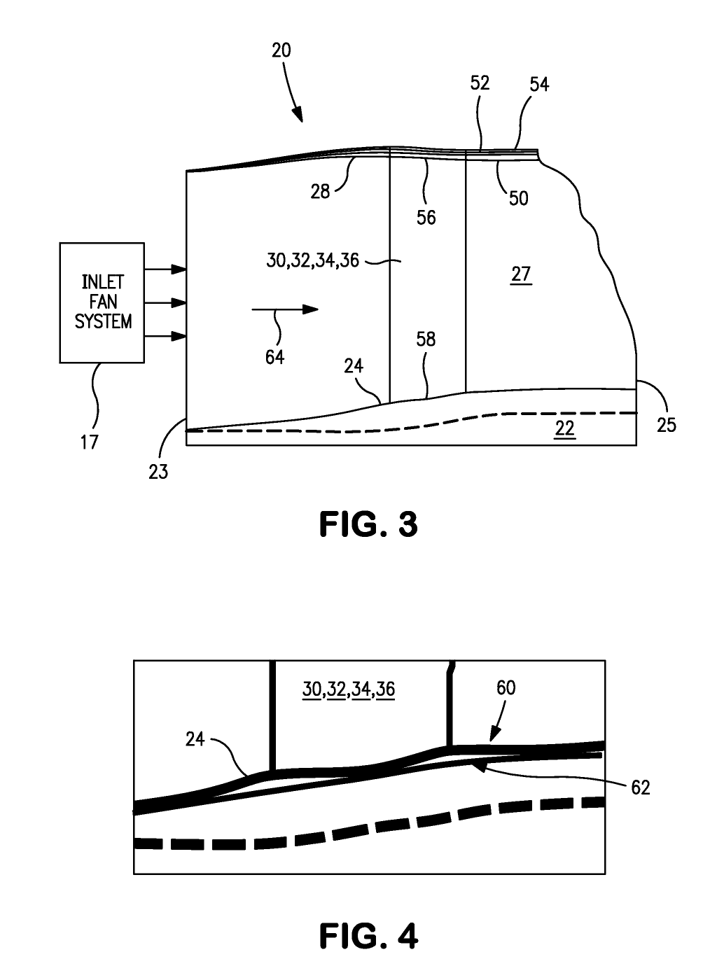

Referring now to FIG. 2, there is shown a rear view of an exit nozzle section 20 of a fan portion of the propulsion engine 16. The exit nozzle section 20 is coupled with an inlet fan system 17. The exit nozzle section 20 has a centerbody 22 with an outer surface that forms an inner wall 24. The exit nozzle section 20 is formed by a casing 26 which has an inner surface which forms an outer wall 28. The outer wall 28 and the inner wall 24 define a flow passageway or gas path 27 for a fluid, such as air which comes from the inlet fan system 17. The flow passageway 27 may converge from the leading edge 23 (FIG. 3) of the exit nozzle section 20 to the trailing edge 25 (FIG. 3) of the exit nozzle section 20.

A plurality of exit guide vanes 30, 32, 34, and 36 may extend between the inner wall 24 and the outer wall 28. While FIG. 2 illustrates only one-half of the exit guide vanes 30, 32, 34, and 36 for the sake of convenience, it should be recognized that there are an equal number of guide vanes 30, 32, 34, and 36 on the other side of FIG. 2 in the same configuration and orientation.

The exit guide vanes 30 extend in a first region 40 which is the bottom region of the exit nozzle section 20. The exit guide vanes 32 extend in a first transition region 42 of the exit nozzle section 20. The exit guide vanes 34 extend in a second transition region 44 of the exit nozzle section 20. The exit guide vanes 36 extend in a second region 46 which is the top region of the exit nozzle section 20. The boundary layer ingestion flow in the various regions 40, 42, 44, and 46 is different in each region.

The gaps between the various exit guide vanes 30, 32, 34, and 36 takes into account flow circumferential variation.

Referring now to FIG. 3, there is shown a cross sectional view of an exit nozzle section 20 with an exit guide vane 30, 32, 34, or 36, extending between the inner wall 24 and the outer wall 28. The outer wall 28 has a non-axisymmetric configuration with respect to the longitudinal centerline 48 of the centerbody 22. FIG. 3 illustrates the different outer wall configurations for the different regions 40, 42, 44, and 46. The innermost line 50 represents the non-axisymmetric configuration of the outer wall 28 in the bottom region 40. The second line 52 represents the non-axisymmetric configuration of the outer wall 28 in the transition region 42. The line 54 represents the non-axisymmetric configuration of the outer wall 28 in the regions 44 and 46. Each exit guide vane 30, 32, 34 and 36 has an outer surface 56 which matches the configuration of the outer wall 28 in its particular region. Thus, the outer surface 56 is also non-axisymmetric with respect to the centerbody centerline 48.

If desired, in an alternative embodiment, the outer wall 28 in the exit nozzle section 20 may be symmetric with respect to the longitudinal centerbody centerline 48.

The various configurations of the outer wall 28 are intended to reduce boundary layer growth and limit non-uniform flow distortion impact on the exit guide vanes 30, 32, 34, and 36.

Each exit guide vane 30, 32, 34, and 36 has an inner surface 58 which meets the inner wall 24. The inner wall 24 is provided with a convergent inner dimension. The inner wall 24 may have an axisymmetric end wall contouring or no end-wall contouring. Referring now to FIG. 4, there is illustrated the flow path 60 with axisymmetric end wall contouring and the flow path 62 with no end wall contouring.

The axisymmetric end wall contouring is designed to reduce losses and inner dimension separation associated with thick (developed) boundary layers.

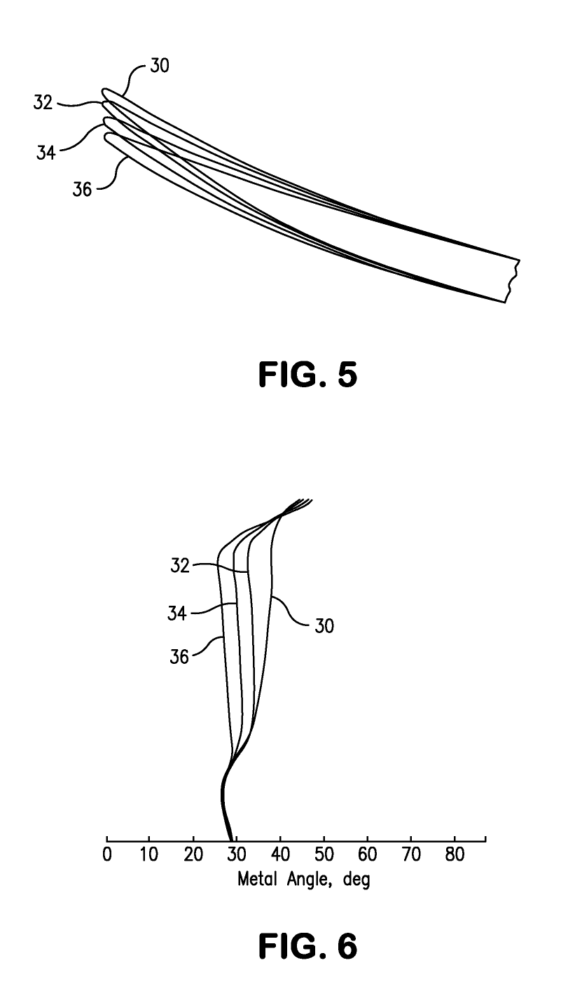

Referring now to FIG. 5, there is shown the different cambers for the different exit guide vanes 30, 32, 34, and 36 in the presence of distortion. The tailored camber design accounts for flow distortion within the exit nozzle section 20.

Referring now to FIG. 6, there is shown the different leading edge metal angles in degrees for the different exit vanes 30, 32, 34, and 36 with respect to the flow path 64 (FIG. 3). The leading edge metal angles were repositioned for each individual vane or group of vanes to account for the local axial and radial flow angle.

The exit nozzle section and exit guide vane design described hereinabove reduces total pressure losses, eliminates vane and end-wall separation and increases mixing/reduces wake associated with the incoming distortion from the blended wing body inlet fan system. The exit nozzle section and exit guide vane design shown herein also potentially reduces noise. Still further, the exit nozzle section and exit guide vane design should maintain or increase the stability margin when coupled with an inlet-fan system.

There has been provided herein a non-axisymmetric exit guide vane design. While the non-axisymmetric exit guide vane design has been described in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. An exit nozzle section for an engine comprising:
an outer wall and an inner wall;
a plurality of exit guide vanes extending between said outer wall and said inner wall; and
different ones of said exit guide vanes having different cambers in different regions of said exit nozzle section.

2. The exit nozzle section of claim 1, wherein said exit guide vanes have different leading edge metal angles in said different regions of said exit nozzle section.

3. The exit nozzle section of claim 1, wherein said different regions of said exit nozzle section comprise a bottom region, a top region, and at least one transition region between said bottom region and said top region.

4. The exit nozzle section of claim 1, wherein said outer wall and said inner wall form a convergent flow passageway.

5. The exit nozzle section of claim 1, wherein said outer wall comprises a non-axisymmetric outer dimension.

6. The exit nozzle section of claim 1, wherein said outer wall has different configurations in said different regions of said exit nozzle section.

7. The exit nozzle section of claim 1, wherein said outer wall comprises a symmetric outer dimension.

8. The exit nozzle section of claim 1, wherein said inner wall is convergent with respect to said outer wall.

9. The exit nozzle section of claim 8, wherein said inner wall comprises axisymmetric end-wall contouring.

10. The exit nozzle section of claim 8, wherein said inner wall has no end wall contouring.

11. The exit nozzle section of claim 1, wherein each said guide vane has an inner dimension which corresponds to a configuration of said inner wall and an outer dimension which corresponds to a configuration of said outer wall.

12. The exit nozzle section of claim 1, wherein said outer wall is formed by a surface of a casing.

13. The exit nozzle section of claim 1, further comprising a centerbody in said exit nozzle section and a surface of said centerbody forming said inner wall.

14. The exit nozzle section of claim 2, wherein said inner wall converges towards said outer wall to form a convergent flow path and said outer wall has a non-axisymmetric configuration in said different regions of said exit nozzle section.
